(19) United States
(12) Patent Application Publication
(10) Pub. No.: US 2026/0223843 A1
(43) Pub. Date: Aug. 6, 2026

(54) INSECTICIDE ENHANCER

(71) Applicant: FYTEKO SA, Anderlecht (BE)

(72) Inventors: Guillaume WEGRIA, Anderlecht (BE); Juan-Carlos CABRERA PINO, Anderlecht (BE)

(21) Appl. No.: 18/997,133

(22) PCT Filed: Jul. 25, 2023
(86) PCT No.: PCT/EP2023/070512

§ 371 Date: Jan. 20, 2025

(30) Foreign Application Priority Data
Jul. 26, 2022 (EP) 22186977.9

(51) Int. Cl. A01N 37/38; A01N 41/10; A01N 43/56; A01N 47/06; A01N 51/00; A01P 7/04

(52) U.S. Cl. CPC A01N 37/38; A01N 41/10; A01N 43/56; A01N 47/06; A01N 51/00; A01P 7/04

(57) ABSTRACT

The current invention relates to an insecticidal composition comprising: an insecticide and a polyferulate. The invention also relates to a method for the control of pests in a variety of crops, and industrial vegetation or crop management. The invention further relates to a kit for the control of pests in a variety of crops, and industrial vegetation or crop management comprising an insecticidal composition as an in-can or in tank mix.

### FIELD OF THE INVENTION

The present invention relates to an insecticidal composition. In a second aspect, the present invention also relates to a method for the control of pests in a variety of crops, and industrial vegetation or crop management. In a third aspect, the present invention also relates to a kit for the control of pests in a variety of crops, and industrial vegetation or crop management.

### BACKGROUND

Insecticides are substances used to kill insects. They have been widely used to control noxious insects in agriculture, forestry, horticulture, public health, and medicine. Their use in agriculture has contributed dramatic increases in crop production and in the quantity and variety of the diet. Insecticides have also played a crucial role in limiting the spread of human and animal vector-borne diseases. Insecticides can be classified in any of several ways, on the basis of their chemistry, their toxicological action, or their mode of penetration.

In relation with the mode of penetration, insecticides can be classified into two major groups: systemic insecticides, which have residual or long-term activity; and contact insecticides, which have no residual activity. Unlike typical contact insecticides, that are usually taken up through the arthropod's cuticle or skin of animals, systemic insecticides get into the organisms mainly through feeding on the treated plants or contaminated soil. Therefore, a systemic insecticide is absorbed into a plant and distributed throughout its tissues, reaching the plant's stem, leaves, roots, and any fruits or flowers. In general, systemic insecticides are water-soluble, so they easily move throughout a plant as it absorbs water and transports it to its tissues.

The advent of synthetic insecticides in the mid-20th century made the control of insects and other arthropod pests much more effective, and such chemicals remain essential in modern agriculture despite their environmental drawbacks. But the use of insecticides has also resulted in several serious problems, among them environmental contamination and the development of resistance in pest species.

A way to reduce these problems is to enhance the efficacy of the pesticidal formulation. U.S. Pat. No. 10,342,228 describes a composition for biocide enhancement, comprising a polyelectrolyte complex of a polyanion and a polycation, and at least one biocide. The polyelectrolyte complex provides a synergistic effect to said biocide.

Known compositions have often an environmentally polluting production processes, do not reduce the toxicity, are not plant based, require frequent reapplication, are not as effective or are difficult to produce. A solution to these problems are the use of bio-insecticides that are generally less pollutant, less toxic and biobased. However, the inconsistency of the efficacy and cost of many biopesticides is the primary factor restricting their widespread use. Enhancement of insecticides with bio-based polymers is an innovative strategy to suppress insect populations to an economic threshold level.

Insecticidal compositions which allows for reduced effective dosage rates, increased environmental safety and lower incidence of insect resistance are highly desirable.

### SUMMARY OF THE INVENTION

The present invention and embodiments thereof serve to provide a solution to one or more of above-mentioned disadvantages. To this end, the present invention relates, in a first aspect, to an insecticidal composition, comprising: an insecticide and polyferulate. Preferably the polyferulate have an average molecular mass higher than 400 g/mol, and the weight ratio of the insecticide over the polyferulate is between 1:10 and 1000:1.

The composition as described herein is particularly advantageous because polyferulate are bio-based, safe to use, have high bioavailability, and furthermore aid in efficiently combating pests in plants without negatively impacting the plant growth and/or harvest yield.

In a second aspect, the present invention relates to a method for the control of pests in a variety of crops, and industrial vegetation or crop management according to claim 9. The polyferulate cause no toxicity if applied alone but enhance the activity of the insecticide. Therefore, lower quantities of insecticide should be applied while maintaining the same efficacy.

In a third aspect the present invention relates to a kit according to claim 13. The composition can be used in-can (co-formulated products) or in tank mix, whereby the polyferulate are formulated as adjuvant and added to the insecticide in the tank mix or are applied in a premix concentrate. The use of the kit of the composition described herein, provides an easy way to apply product with potentially different pesticides.

### DESCRIPTION OF FIGURES

The following description of the figures of specific embodiments of the invention is merely exemplary in nature and is not intended to limit the present teachings, their application or uses. Throughout the drawings, corresponding reference numerals indicate like or corresponding parts and features.

FIG. 1 shows an overlaid SEC chromatograms of the ferulic acid (starting of the reaction) and polyferulate (end product) according to an embodiment of the present invention.

FIG. 2 shows a UV spectra of ferulic acid and polyferulate according to an embodiment of the present invention.

FIG. 3 shows a FT-IR spectra of ferulic acid and polyferulate of an embodiment of the present invention.

### DETAILED DESCRIPTION OF THE INVENTION

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

As used herein, the following terms have the following meanings:

“A”, “an”, and “the” as used herein refers to both singular and plural referents unless the context clearly dictates otherwise. By way of example, “a compartment” refers to one or more than one compartment.

“Comprise”, “comprising”, and “comprises” and “comprised of” as used herein are synonymous with “include”, “including”, “includes” or “contain”, “containing”, “contains” and are inclusive or open-ended terms that specifies the presence of what follows e.g. component and do not exclude or preclude the presence of additional, non-recited components, features, element, members, steps, known in the art or disclosed therein.

The recitation of numerical ranges by endpoints includes all numbers and fractions subsumed within that range, as well as the recited endpoints.

The expression “% by weight”, “weight percent”, “% wt” or “wt %”, here and throughout the description unless otherwise defined, refers to the relative weight of the respective component based on the overall weight.

Whereas the terms “one or more” or “at least one”, such as one or more or at least one member(s) of a group of members, is clear per se, by means of further exemplification, the term encompasses inter alia a reference to any one of said members, or to any two or more of said members, such as, e.g., any ≥3, ≥4, ≥5, ≥6 or ≥7 etc. of said members, and up to all said members.

Unless otherwise defined, all terms used in disclosing the invention, including technical and scientific terms, have the meaning as commonly understood by one of ordinary skill in the art to which this invention belongs. By means of further guidance, definitions for the terms used in the description are included to better appreciate the teaching of the present invention. The terms or definitions used herein are provided solely to aid in the understanding of the invention.

A synergistic effect does always exist for insecticide, if the insecticidal efficacy of the combinations or compositions according to the invention is greater than the expected efficacy for the combination of two active compounds according to S. R. Colby (“Calculation of the synergistic and antagonistic responses of herbicide combinations” Weeds, (1967), 15, pages 20-22) which is calculated as shown below:

If X is the efficacy observed for compound (A) at a defined dose (m g/ha or m ppm), Y is the efficacy observed for compound (B) at a defined dose (n g/ha or n ppm), E is the efficacy observed for compound (A) and compound (B) together at defined doses of m and n g/ha or m and n ppm, then the Colby formula can be defined as:

E=X+Y−((X*Y)/100).

The efficacies are calculated as %. 0% efficacy is corresponding to the non-treated, fully infected control, while an efficacy of 100% implies that no infection at all can be observed. In case that the insecticidal effect actual observed is greater than the efficacy calculated using Colby's formula, the combinations or compositions are superadditive, i. e. a synergistic effect can be observed. The term “synergistic effect” also means the effect defined by application of the Tammes method, “Isoboles, a graphic representation of synergism in pesticides”, Netherlands Journal of Plant Pathology, 70 (1964), pages 73-80.

“Polyferulate” is a polymer of ferulic acid. Ferulic acid, also known as (2E)-3-(4-hydroxy-3methoxyphenyl) prop-2-enoic acid, is a hydroxycinnamic acid. A polymer comprises at least two monomers. After polymerization of ferulic acid, a wide variety of chemical structures can be obtained because ferulic acid contains several reactive groups. Therefore, the degree of polymerization can be determined based on the molecular mass. A polymer comprises no monomer but it is possible to comprise several oligomers and many different polymers.

In a first aspect, the invention relates to an insecticidal composition comprising: an insecticide and a polyferulate. The inventors have unexpectedly observed that polyferulate can improve the effect of insecticides without having plant toxic properties. The applied insecticide dose can be reduced, when mixed with the polyferulate, while maintaining the same efficiency compared to the required dose of insecticide without polyerulate.

In an embodiment, the weight ratio of the insecticide over the polyferulate is between 1:100 and 10 000:1, and more preferably between 1:100 and 2000:1. In an embodiment, the weight ratio of the insecticide to the polyferulate is between 1:10 and 1000:1, preferably 1:10 and 500:1, more preferably between 1:8 and 400:1, even more preferably between 1:5 and 250:1 and most preferably between 1:4 and 200:1. In an embodiment the weight ratio of the insecticide to the polyferulate is between 1:1 and 100:1.

In an embodiment, the average molecular mass of the polyferulate in the composition is higher than 400 g/mol and more preferably between 1000 and 30 000 g/mol. In an embodiment, polyferulate comprise polymers and oligomers of ferulic acid. In an embodiment, at least 10 wt. % of the polyferulate have a molecular mass of 400-2000 g/mol. In an embodiment, at least 90 wt. % of the polyferulate have a molecular mass of at least 400 g/mol, preferably at least 1000 g/mol. In an embodiment, 5-30 wt. % of the polyferulate have a molecular mass of 250-400 g/mol. In an embodiment, 20-80 wt. % of the polyferulate have a molecular mass of 5000-30 000 g/mol, preferably 50-70 wt. % of the polyferulate have a molecular mass of 7500-25 000 g/mol.

An average molecular mass of the polyferulate in the composition higher than 400 g/mol, showed better insecticidal effects compared to compositions with ferulic acid derivates of lower molecular mass or ferulic acid. In an embodiment, the ferulic acid dimer is present in the composition. In an embodiment, the composition comprises 0.01-10 wt. % dimer of ferulic acid.

In an embodiment, the weight ratio between said insecticide and the polyferulate is between 1:8 and 300:1, more preferably between 1:5 and 100:1, even more preferably between 1:3 and 50:1, and most preferably between 1:2 and 40:1.

In an embodiment, the insecticidal composition further comprises ferulic acid or a salt thereof. In an embodiment, the weight ratio of ferulic acid or a salt thereof over the polyferulate is between 1:1 and 1:1000.

In an embodiment, the insecticidal composition further comprises a monomer or polymer of an organic acid selected from: cinnamic acid (also known as (2E)-3-Phenylprop-2-enoic acid), caffeic acid (also known as 3-(3,4-dihydroxyphenyl)-2-propenoic acid), ortho-coumaric acid (also known as (2E)-3-(2-hydroxyphenyl) prop-2-enoic acid) and sinapic acid (also known as (2E)-3-(4-Hydroxy-3,5-dimethoxyphenyl) prop-2-enoic acid).

In an embodiment, the insecticide is a systemic insecticide. A systemic insecticide is absorbed by and transported through plants. Systemic insecticides can render some or all of a plant toxic to insects that feed on plant tissue. Thus, they are commonly used to suppress herbivorous sucking or chewing insects like aphids, caterpillars, and root nematodes. Unfortunately, systemic insecticides harm both target insects and non-target beneficial insects. In an embodiment, the insecticide is selected from: imidacloprid and thiacloprid, clothianidin, thiamethoxam, acetamiprid, nitenpyram, and dinotefuran.

In an embodiment, the insecticide is imidacloprid (commercial product: ADMIRE®, Bayer) Bacillus thuringiensis (commercial product: TUREX®, Certis USA), teflubenzuron (commercial product: NOMOLT®, BASF), pymetrozine (commercial product: PLENUM®, Syngenta) and acetamiprid (Commercial product: GAZELLE®, Certis Europe), ACTELLIC® Syngenta, Switserland), Pyrethroids (commercial product BAYGON® (Bayer), bifenazate (e.g. Uniroyal), dichlorvos (e.g. Amvac Chemical Corporation), imidacloprid (e.g. Bayer), fenamiphos (e.g. Mobay Chemical Corporation), orange oil, D-limonene, oxamyl (e.g. Dupont) or any sulfur-based insecticide. A composition of the invention may also comprise two or more insecticides.

In an embodiment, the polyferulate are prepared by oxidation and subsequent polymerization of biobased ferulic acid and is facilitated by an enzyme. In an embodiment, the polyferulate are produced from a reaction mixture. In an embodiment, the initial reaction mixture comprises and preferably consists of:
potassium phosphate buffer, preferably 40-60 volume % of 30-70 mM of pH 5-7;
methanol, preferably 20-40 volume %;
a peroxidase, preferably 0.02-0.5 volume % of 0.5-2% Horseradish peroxidase (HRP) solution, more preferably with an activity of 100-200 units/mg; and
a ferulic acid solution, preferably 10-25 volume % of methanol solution of ferulic acid (5-20 g/L).

In an embodiment, 0.6% hydrogen peroxide is added dropwise to the reaction mixture. In an embodiment, 0.001-0.5 volume % of the initial reaction mixture volume of hydrogen peroxide is added per minute. In an embodiment, the reaction is monitored simultaneously by FPLC-SEC. In an embodiment, the reaction is carried out at 20-40° C. until neither monomeric ferulic acid nor small oligomers are detected in the reaction mixture. In an embodiment, the reaction is continued for 24-72 h, preferably 48 h. In an embodiment, the polyferulate are isolated by precipitation at low pH and purified by washing, preferably with cold water. In an embodiment, the polyferulate are freeze-dried.

In an embodiment, the insecticide has a mode of action (MoA), as indicated and labelled by Insecticide Resistance Action Committee (IRAC) selected from:
1-Acetylcholinesterase (AChE) inhibitors
2-GABA-gated chloride channel blockers
3-Sodium channel modulators
4-Nicotinic acetylcholine receptor (nAChR) competitive modulators
5-Nicotinic acetylcholine receptor (nAChR) allosteric modulators—Site I
6-Glutamate-gated chloride channel (GluCl) allosteric modulators
7-Juvenile hormone mimics
8-Miscellaneous non-specific (multi-site) inhibitors
9-Chordotonal organ TRPV channel modulators
10-Mite growth inhibitors affecting CHS1
11-Microbial disruptors of insect midgut membranes
12-Inhibitors of mitochondrial ATP synthase
13-Uncouplers of oxidative phosphorylation via disruption of the proton gradient
14-Nicotinic acetylcholine receptor (nAChR) channel blockers
15-Inhibitors of chitin biosynthesis affecting CHS1
16-Inhibitors of chitin biosynthesis, type 1
17-Moulting disruptors, Dipteran
18-Ecdysone receptor agonists
19-Octopamine receptor agonists
20-Mitochondrial complex III electron transport inhibitors
21-Mitochondrial complex I electron transport inhibitors
22-Voltage-dependent sodium channel blockers
23-Inhibitors of acetyl CoA carboxylase
24-Mitochondrial complex IV electron transport inhibitors
25-Mitochondrial complex II electron transport inhibitors
28-Ryanodine receptor modulators
29-Chordotonal organ Modulators-undefined target site
30-GABA-gated chloride channel allosteric modulators
31-Baculoviruses
32-Nicotinic Acetylcholine Receptor (nAChR) Allosteric Modulators-Site II
UN-Compounds of unknown or uncertain MoA
UNB-Bacterial agents (non-Bt) of unknown or uncertain MoA
UNE-Botanical essence including synthetic, extracts and unrefined oils with unknown or uncertain MoA
UNF-Fungal agents of unknown or uncertain MoA
UNM-Non-specific mechanical disruptors
UNP-Peptides of unknown or uncertain MoA
UNV-Viral agents (non-baculovirus) of unknown or uncertain MoA.

In an embodiment, the insecticide of the composition has a mode of action (MoA), as indicated and labelled by Insecticide Resistance Action Committee (IRAC), selected from any of the groups. In an embodiment, the insecticide can be chosen from any of the different groups or any combination of different groups.

In an embodiment, the insecticide has a mode of action (MoA), as indicated and labelled by Insecticide Resistance Action Committee (IRAC), selected from the groups with code 1, 2, 3 and 4. In an embodiment, the insecticide has a mode of action (MoA), as indicated and labelled by Insecticide Resistance Action Committee (IRAC), selected from the groups with code 5, 6, 7, 8 and 9. In an embodiment, the insecticide has a mode of action (MoA), as indicated and labelled by Insecticide Resistance Action Committee (IRAC), selected from the groups with code 10, 11, 12, 13 and 14. In an embodiment, the insecticide has a mode of action (MoA), as indicated and labelled by Insecticide Resistance Action Committee (IRAC), selected from the groups with code 15, 16, 17, 18 and 19. In an embodiment, the insecticide has a mode of action (MoA), as indicated and labelled by Insecticide Resistance Action Committee (IRAC), selected from the groups with code 20, 21, 22, 23 and 24. In an embodiment, the insecticide has a mode of action (MoA), as indicated and labelled by Insecticide Resistance Action Committee (IRAC), selected from the groups with code 25, 26, 27, 28 and 29. In an embodiment, the insecticide has a mode of action (MoA), as indicated and labelled by Insecticide Resistance Action Committee (IRAC), selected from the groups with code 30, 31 and 32. In an embodiment, the insecticide has a mode of action (MoA), as indicated and labelled by Insecticide Resistance Action Committee (IRAC), selected from the groups with code UN, UNB, UNE, UNF, UNM, UNP, and UNV.

In an embodiment, the insecticidal composition further comprises a hydrophilic and/or a lipophilic surfactant, wherein said hydrophilic and/or lipophilic surfactant have a concentration of between 0.01 and 30.00 wt. % based on the total weight of said composition. In an embodiment, the insecticidal composition further comprises a hydrophilic and/or a lipophilic surfactant, wherein said hydrophilic and/or lipophilic surfactant have a concentration of between 0.1 and 20 wt. % based on the total weight of said composition, preferably 0.5-5 wt. %, more preferably 0.5-3 wt. %. In an embodiment, the surfactant is anionic. In an embodiment, the surfactant is cationic. In an embodiment, the surfactant is a polyol. In an embodiment, the insecticidal composition further comprises a hydrophilic and/or a lipophilic surfactant, wherein said hydrophilic and/or lipophilic surfactant have a concentration of between 0.1 and 20 wt. % based on the total weight of the insecticide, preferably 0.5-10 wt. %, more preferably 0.5-5 wt. %.

In an embodiment, the insecticidal composition has a pH of between 1 and 12, preferably between 5 and 8, preferably between 5 and 7. It was found that the composition has a better insecticidal effect when applied at a slightly acid pH.

In an embodiment, the insecticide is selected from the chemical family of: Acequinocyl, Alkyl halides, Amitraz, Avermectin, Avermectins, Benzoylureas, beta-Ketonitrile derivatives, Bifenazate, Borates, Botanical, Buprofezin, Butenolide, Butenolides, Carbamates, Carboxanilides, Chloropicrin, Clofentezine, Cyanides, Cyclodiene Organochlorines, Cyromazine, Cyromazine, Diacylhydrazine, Diacylhydrazines, Diafenthiuron, Diamide, Diamides, Diflovidazin, Dinitrophenols, Etoxazole, Fenoxycarb, Flonicamid, Fluacrypyrim, Fluorides, Hexythiazox, Hydramethylnon, Juvenile hormone analogues, Mesoionics, Methyl isothiocyanate generators, Milbemycins, Neonicotinoid, Nereistoxin analogues, Organophosphates, Organotin miticides, Oxadiazines, Phenylpyrazoles, Phosphides, Propargite, Pyrethroid, Pyridine azomethine, Pyridine azomethine derivatives, Pyridinecarboxamide, Pyridylidenes, Pyriproxyfen, Pyropenes, Pyrroles, Quinazoline, Semicarbazones, Spinosyns, Sulfluramid, Sulfoximines, Tartar emetic, Tetradifon, Tetronic and Tetramic acid derivatives and veratrum alkaloids.

In an embodiment, the insecticide can be chosen from any of the different chemical families or any combination of different chemical families. In an embodiment, the insecticide is selected from the chemical family of: Acequinocyl, Alkyl halides, Amitraz, Avermectin, Avermectins, Benzoylureas, beta-Ketonitrile derivatives and Bifenazate. In an embodiment, the insecticide is selected from the chemical family of: Borates, Botanical, Buprofezin, Butenolide, Butenolides, Carbamates, Carboxanilides, Chloropicrin, Clofentezine and Cyanides. In an embodiment, the insecticide is selected from the chemical family of: Cyclodiene Organochlorines, Cyromazine, Cyromazine, Diacylhydrazine, Diacylhydrazines, Diafenthiuron, Diamide, Diamides, Diflovidazin, Dinitrophenols, Etoxazole, Fenoxycarb, Flonicamid, Fluacrypyrim, Fluorides and Hexythiazox. In an embodiment, the insecticide is selected from the chemical family of: Hydramethylnon, Juvenile hormone analogues, Mesoionics, Methyl isothiocyanate generators, Milbemycins, Neonicotinoid, Nereistoxin analogues, Organophosphates, Organotin miticides, Oxadiazines, Phenylpyrazoles, Phosphides and Propargite. In an embodiment, the insecticide is selected from the chemical family of: Pyrethroid, Pyridine azomethine, Pyridine azomethine derivatives, Pyridinecarboxamide, Pyridylidenes, Pyriproxyfen, Pyropenes, Pyrroles and Quinazoline. In an embodiment, the insecticide is selected from the chemical family of: Semicarbazones, Spinosyns, Sulfluramid, Sulfoximines, Tartar emetic, Tetradifon, Tetronic and Tetramic acid derivatives and veratrum alkaloids.

In a second aspect, the invention relates to a method for the control of pests in a variety of crops, and industrial vegetation or crop management comprising the step of applying an insecticidal composition, wherein the insecticidal composition comprises an insecticide and a polyferulate. The inventors have unexpectedly observed that polyferulate can improve the effect of insecticides without having plant toxic properties. The applied insecticide dose can be reduced, when mixed with the polyferulate, while maintaining the same efficiency compared to the required dose of insecticide without polyerulates.

In a preferred embodiment of the invention, the insecticide is applied at 10-90% of its recommended dose, more preferably between 25-75%, and polyferulate are applied at a dose of 1-250 g active ingredient (a.i.)/ha, more preferably between 5-100 g a.i./ha, and most preferably between 10-25 g a.i./ha. In an embodiment, the insecticide is applied at 30-70% of its recommended dose, preferably 40-60% of its recommended dose. In an embodiment, polyferulate are applied at a dose of 1-250 g a.i./ha, more preferably between 10-100 g a.i./ha and most preferably between 10-25 g a.i./ha. In an embodiment, all polyferulate, are considered active ingredients.

In a preferred embodiment of the invention, the polyferulate are applied to the targeted plant before, simultaneously with, or after application of the insecticide.

In a preferred embodiment of the invention, the polyferulate are applied to the targeted plant simultaneously with the insecticide or in a period of up to 10 days prior to or after applying the insecticide. In an embodiment, the method comprises: applying an insecticide at 25-75% of its recommended dose, preferably 40-60% of its recommended dose, if applied alone, and applying 10-25 g polyferulate/ha simultaneously with the insecticide or in a period of 10 days prior to or after applying the insecticide. Preferably the time difference between the application of the insecticide and the polyferulate is less than 72 hours, more preferably the application of the insecticide and the polyferulate is simultaneously.

According to some embodiments, applying the composition comprises foliar application through spraying of the composition on leaves of the weeds. Spraying of the composition is a particularly favorable method of application as it allows homogeneous distribution of the composition over the weeds. Furthermore, spraying is a very fast method of distributing the composition, allowing the treatment of a large surface area of plants.

The insecticidal composition comprising an insecticide and polyerulates, can be formulated together in an appropriate ratio of the present invention, together with conventional formulation aids as known in the art, such as, for example, one or more carriers.

In a preferred embodiment, the insecticidal composition of the present invention further comprises one or more additional components selected from the group comprising other pesticides such as herbicides, insecticides, fungicides or other active pesticide ingredients, safeners, antioxidants, chemical stabilizers, adhesives, fertilizers, perfumes, colorants, liquid carriers, solid carriers, surface-active agents, crystallization inhibitors, viscosity modifiers, suspending agents, spray droplet modifiers, pigments, foaming agents, light-blocking agents, compatibility agents, antifoam agents, sequestering agents, neutralizing agents and buffers, wetting and dispersing agents, preservatives, thickening agents, corrosion inhibitors, freezing point depressants, odorants, spreading agents, penetration aids, micronutrients, emollients, lubricants, sticking agents and humectants, such as, for example, propylene glycol. According to preferred embodiments, the insecticidal composition can also comprise various agrochemically active compounds, for example from the group of the acaricides, nematicides, bird repellants, and soil structure improvers.

In a third aspect, the invention relates to a kit for the control of pests in a variety of crops, and industrial vegetation or crop management comprising an insecticidal composition as an in-can or in tank mix, wherein the insecticidal composition comprises a polyferulate and an insecticide, wherein the polyferulate are formulated as adjuvant and added to the insecticide in the tank mix or are applied in a premix concentrate. An in-can mix implies that the insecticide and the polyferulate are co-formulated.

In a preferred embodiment of the invention, the insecticidal composition further comprises a hydrophilic and/or a lipophilic surfactant, wherein said hydrophilic and/or lipophilic surfactant have a concentration of between 0.01 and 30.00 wt. % based on the total weight of said composition. In an embodiment, the insecticidal composition further comprises a hydrophilic and/or a lipophilic surfactant, wherein said hydrophilic and/or lipophilic surfactant have a concentration of between 0.1 and 20 wt. % based on the total weight of said composition, preferably 0.5-5 wt. %, more preferably 0.5-3 wt. %. In an embodiment, the surfactant is anionic. In an embodiment, the surfactant is cationic. In an embodiment, the surfactant is a polyol. In an embodiment, the insecticidal composition further comprises a hydrophilic and/or a lipophilic surfactant, wherein said hydrophilic and/or lipophilic surfactant have a concentration of between 0.1 and 20 wt. % based on the total weight of the insecticide, preferably 0.5-10 wt. %, more preferably 0.5-5 wt. %.

In a preferred embodiment of the invention, the insecticidal composition has a pH of between 1 and 12, preferably between 5 and 8. The inventors have unexpectedly observed that the composition has a better insecticidal effect when applied at a slightly acid pH.

The skilled person will realize that the composition according to the first aspect can be applied via a method described in the second aspect and that the method described in the second aspect is conducted using the composition described in the first aspect. Each embodiment or characteristic described in this document, above and below, can thus be applied to each of the 3 aspects of the invention.

The present invention is in no way limited to the embodiments described in the examples and shown in the figures. On the contrary, methods according to the present invention may be realized in many different ways without departing from the scope of the invention.

### DESCRIPTION OF FIGURES

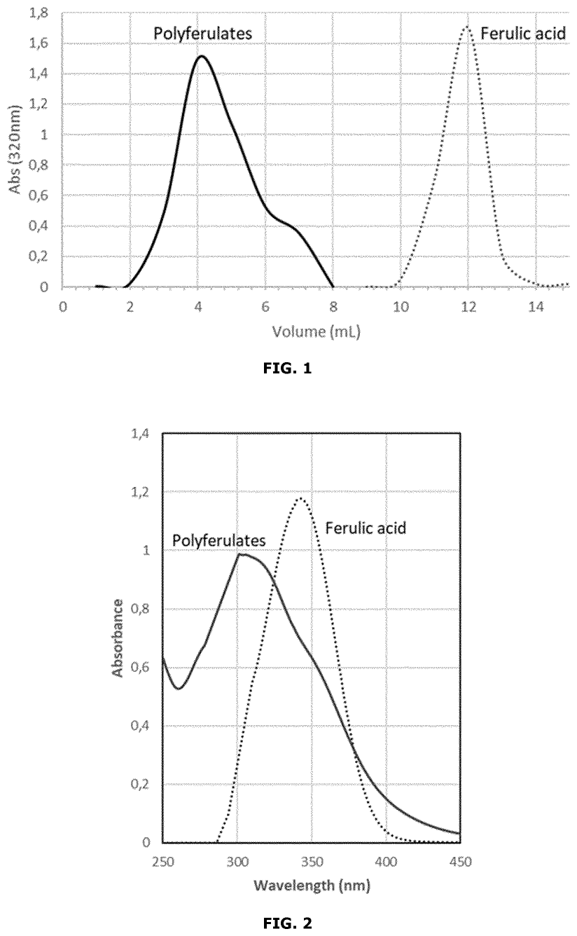

FIG. 1 shows overlaid SEC chromatograms, obtained using a Sephacryl S-200 column. High molecular weight polyferulate are eluted from the column first. Monomeric ferulic acid was eluted afterwards. The absence of overlapping between the two chromatograms confirms the absence of monomeric ferulic acid residues in the final product.

The structural differences between the initial product (ferulic acid) and the final product (polyferulate) were confirmed by UV analysis (FIG. 2). In the UV absorption spectrum of polyferulate, a shift of about 44 nm of the band at 344 nm with respect to ferulic acid was observed. This shift was undoubtedly due to the formation of the polymerization bond between ferulate units.

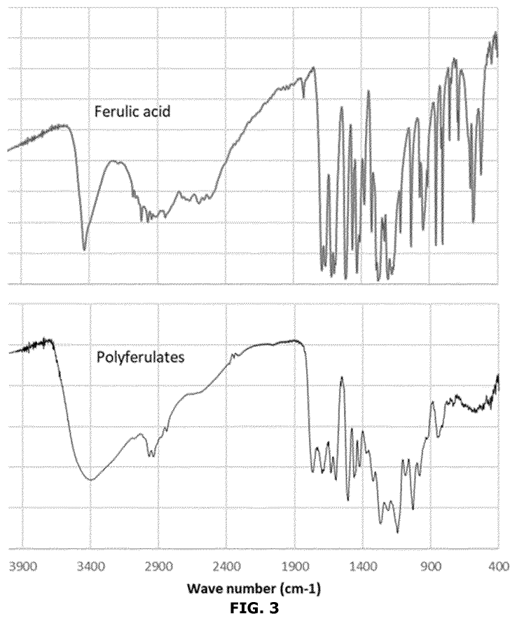

FIG. 3 shows the FTIR spectra of polyferulate and ferulic acid which are significantly different. The broadening of the signal at 3400 cm−1 in the polyferulate spectrum indicates the presence of a higher numbers of labile proton due to carboxylic acid groups and phenolic groups in polyferulate, the smaller signals at 3000 cm−1, characteristic of the stretching of the C—H bonds of the aromatic groups, is slightly more intense and better resolved because of the large number of aromatic rings in the polyferulate. Additionally, the signal at 1700 cm−1 characteristic of the carboxylic functions is much less intense for the polyferulate. This could be due to the three-dimensional arrangement of the polyferulate which may limit the possibilities of vibrations of the C=0 double bonds.

### EXAMPLES

The very good insecticide effect of the combinations or compositions according to the invention is shown in the following example. While the single active compounds do show weaknesses in their insecticidal efficacy, the combinations or compositions show an effect which is greater than the single addition of the efficacies of each compound. The present invention will now be further exemplified with reference to the following examples.

### Example 1. Preparation of Polyferulate

Polyferulate are prepared by an eco-friendly procedure. The oxidation and subsequent polymerization of biobased ferulic acid is facilitated by an enzyme. The reaction mixture comprises 3 L of 50 mM potassium phosphate buffer, pH 6.0, 2 L of methanol, 20 ml of 1% Horseradish peroxidase (HRP) solution (with activity of 150 units/mg), 1 L of methanol solution of ferulic acid (10 g/L) and 0.6% hydrogen peroxide (400 ml) added dropwise at 0.5 mL/min. The reaction is monitored simultaneously by FPLC-SEC using a column of Sephacryl S-200 and LC-MS. The reaction is carried out at 30° C. until neither monomeric ferulic acid nor small oligomers are detected in the reaction mixture (around 48 h). The polyferulate are isolated by precipitation at low pH and purified by washing with cold water and freeze-dried.

### Example 2: Compositions Comprising Polyferulate and Chemical Insecticide Active Ingredient (AI)

The tables below (1-5) contain example compositions comprising both a polyferulate and an insecticide according to the present invention. The polyferulate herein serves as a synergistic, i.e. aids enhancing insecticides activities in the pests.

TABLE 1
Polyferulate and insecticide composition I

| Component | Function | Rate |
|---|---|---|
| Polyferulate | Synergistic agent | 24.00 g a.i. ha⁻¹ |
| Chlorantraniliprole | Insecticide | 22.50 g a.i. ha⁻¹ |
| Water | Solvent | 500 Kg. ha⁻¹ |

TABLE 2
Polyferulate and insecticide composition II

| Component | Function | Rate |
|---|---|---|
| Polyferulate | Synergistic agent | 24.00 g a.i. ha⁻¹ |
| Cyantraniliprole | Insecticide | 67.50 g a.i. ha⁻¹ |
| Water | Solvent | 500 Kg. ha⁻¹ |

TABLE 3
Polyferulate and insecticide composition III

| Component | Function | Rate |
|---|---|---|
| Polyferulate | Synergistic agent | 12.00 g a.i. ha⁻¹ |
| Spirotetramat | Insecticide | 56.00 g a.i. ha⁻¹ |
| Water | Solvent | 300 Kg. ha⁻¹ |

TABLE 4
Polyferulate and insecticide composition IV

| Component | Function | Rate |
|---|---|---|
| Polyferulate | Synergistic agent | 12.00 g a.i. ha⁻¹ |
| Flubendiamide | Insecticide | 18.00 g a.i. ha⁻¹ |
| Water | Solvent | 400 Kg. ha⁻¹ |

TABLE 5
Polyferulate and insecticide composition V

| Component | Function | Rate |
|---|---|---|
| Polyferulate | Synergistic agent | 24.00 g a.i. ha⁻¹ |
| Imidacloprid | Insecticide | 131.00 g a.i. ha⁻¹ |
| Water | Solvent | 500 Kg. ha⁻¹ |

### Example 3. Synergy of Polyferulate and Insecticides in the Control of Brown Plant Hopper in Rice Plants

To determine the efficacy of insecticides on the mortality percentage of brown planthopper an experiment was conducted in the laboratory. The seedlings of 30-40 days old rice plant (Oryza sativa) were transplanted in plastic pot. The rice plants were grown in plastic pots with Mylar film cage and kept in the laboratory. Rice plants are sprayed with the preparation of the active compound at the desired concentration and are infested with larvae of the brown plant hopper (Nilaparvata lugens) while the rice leaves are still moist. Ten brown planthopper were released in each pot that was selected randomly.

The brown planthopper (BPH), Nilaparvata lugens (Hemiptera: Delphacidae) is a planthopper species that feeds on rice plants (Oryza sativa L.). These insects are among the most important pests of rice, which is the major staple crop for about half the world's population. After 3 days, the mortality in percentage is determined. 100% means that all the hopper larvae have been killed; 0% means that none of the hopper larvae have been killed.

TABLE 6
Control of the brown plant hopper (Nilaparvata
lugens) in rice plants
Control of the Brown plant hopper in rice plants

| | | Observed |
|---|---|---|
| | | efficacy (%) |
| | Concentration | 3 days after |
| Active ingredients | (mg/L) | treatment |
| Polyferulate | 48 | 1 |
| Chlorantraniliprole | 45 | 50 |
| Cyantraniliprole | 135 | 30 |
| Polyferulate + | 48 + 45 | 96 |
| Chlorantraniliprole | | |
| (according with the | | |
| composition I, table 2 to | | |
| this invention) | | |
| | Efficacy | 50.5 |
| | calculated with | |
| | Colby-formula | |
| Polyferulate + | 48 + 135 | 55 |
| Cyantraniliprole | | |
| (according with the | | |
| composition II, table 2 to | | |
| this invention | | |
| | Efficacy | 30.7 |
| | calculated with | |
| | Colby-formula | |

The insecticidal activity (96% and 55%) of the combination exceeds the calculated value (50,5% and 30,7%) of efficacy according to Colby formula. According to the present example the combination shows a synergistic effect in comparison to the single compounds.

### Example 4. Synergy of Polyferulate and Insecticides in the Control of Whitefly in Cotton Plants

Three-week-old cotton plants were defoliated so that only one true leaf remained. 20-30 female adults of B. tabaci were clipped to the underside of the leaf for egg deposition and removed after 16 h. The silverleaf whitefly (Bemisia tabaci, also informally referred to as the sweet potato whitefly) is one of several species of whitefly that are currently important agricultural pests.

Once the 2nd instar nymphs had settled the upper side of the leaf was sprayed using a TLC spraying device (Merck Inc.). Before spraying the number of nymphs was counted on each leaf. The application volume was 500 μL of tested insecticides solutions diluted in tap water. The final concentration of each component appears in the table. Translaminar efficacy was evaluated by counting adults 10 days after application.

TABLE 7
Control of the whitefly (Bemisia tabaci) in cotton plants
Control of whitefly (Bemisia tabaci) in cotton plants

| | | Observed |
|---|---|---|
| | | efficacy (%) |
| | Concentration | 10 days after |
| Active ingredients | (mg/L) | treatment |
| Polyferulate | 4 | 2 |
| Spirotetramat | 18.6 | 75 |
| Imidacloprid | 21.8 | 45 |
| Polyferulate + | 4 + 18.6 | 95 |
| Sprirotetramat (according | | |
| with the composition III, | | |
| table 4 to this invention) | | |
| | Efficacy | 75.5 |
| | calculated with | |
| | Colby-formula | |
| Polyferulate + | 4 + 21.8 | 63 |
| Imidacloprid (according | | |
| with the composition V, | | |
| table 6 to this invention) | | |
| | Efficacy | 46.1 |
| | calculated with | |
| | Colby-formula | |

The insecticidal activity (95% and 63%) of the combinations exceeds the calculated value (75,5% and 46,1%) of efficacy according to Colby formula. According to the present example the combinations shows a synergistic effect in comparison to the single compounds.

### Example 5. Polyferulate Enhances Insecticides Uptake by Leaves of Rice Plants

Rice plants were cultivated in a plant growth chamber with a 12 h day and high intensity lighting. The rice leaves near the roots were smeared with 5 mL of solution containing chlorantraniliprole (100 μg·mL−1) or chlorantraniliprole (100 μg·mL−1) and polyferulate solution (25 μg·mL−1) and covered. When the droplets on the leaves were dried, the plastic was taken away. The rice leaves were harvested 72 h after treated. A sample of the rice leaves (5 g) was weighted and extracted with acetonitrile and the content of uptake chlorantraniliprole determinate by LC-MS/MS. Each experiment was repeated for three replicates.

TABLE 8
Content of chlorantraniliprole in rice leaves

| | Content of |
|---|---|
| | insecticide in |
| | the plant |
| Treatment | material (μg/g) |
| Chlorantraniliprole (100 μg · mL⁻¹) | 38.0 + 0.3 |
| Chlorantraniliprole (100 μg · mL⁻¹) | 78.6 + 0.6 |
| and polyferulate solution (25 μg · | |
| mL⁻¹) | |

This result demonstrates that polyferulate enhanced insecticide uptake by the plant leaves.

1. An insecticidal composition comprising: an insecticide and a polyferulate.

2. The insecticidal composition according to claim 1, wherein the weight ratio of the insecticide over the polyferulate is between 1:10 and 1000:1.

3. The insecticidal composition according to claim 1, wherein an average molecular mass of the polyferulate in the insecticidal composition is higher than 400 g/mol.

4. The insecticidal composition according to claim 1, wherein the weight ratio between said insecticide and the polyferulate is between 1:8 and 300:1.

5. The insecticidal composition according to claim 1, wherein the insecticide has a mode of action (MoA), as indicated and labelled by Insecticide Resistance Action Committee (IRAC) selected from:
1-Acetylcholinesterase (AChE) inhibitors;
2-GABA-gated chloride channel blockers;
3-Sodium channel modulators;
4-Nicotinic acetylcholine receptor (nAChR) competitive modulators;
5-Nicotinic acetylcholine receptor (nAChR) allosteric modulators—Site I;
6-Glutamate-gated chloride channel (GluCl) allosteric modulators;
7-Juvenile hormone mimics;
8-Miscellaneous non-specific (multi-site) inhibitors;
9-Chordotonal organ TRPV channel modulators;
10-Mite growth inhibitors affecting CHS1;
11-Microbial disruptors of insect midgut membranes;
12-Inhibitors of mitochondrial ATP synthase;
13-Uncouplers of oxidative phosphorylation via disruption of the proton gradient;
14-Nicotinic acetylcholine receptor (nAChR) channel blockers;
15-Inhibitors of chitin biosynthesis affecting CHS1;
16-Inhibitors of chitin biosynthesis, type 1;
17-Moulting disruptors, Dipteran;
18-Ecdysone receptor agonists;
19-Octopamine receptor agonists;
20-Mitochondrial complex III electron transport inhibitors;
21-Mitochondrial complex I electron transport inhibitors;
22-Voltage-dependent sodium channel blockers;
23-Inhibitors of acetyl COA carboxylase;
24-Mitochondrial complex IV electron transport inhibitors;
25-Mitochondrial complex II electron transport inhibitors;
28-Ryanodine receptor modulators;
29-Chordotonal organ Modulators-undefined target site;
30-GABA-gated chloride channel allosteric modulators;
31-Baculoviruses;
32-Nicotinic Acetylcholine Receptor (nAChR) Allosteric Modulators-Site II;
UN-Compounds of unknown or uncertain MoA;
UNB-Bacterial agents (non-Bt) of unknown or uncertain MoA;
UNE-Botanical essence including synthetic, extracts and unrefined oils with unknown or uncertain MoA;
UNF-Fungal agents of unknown or uncertain MoA;
UNM-Non-specific mechanical disruptors;
UNP-Peptides of unknown or uncertain MoA; or
UNV-Viral agents (non-baculovirus) of unknown or uncertain MoA.

6. The insecticidal composition according to claim 1, wherein the insecticidal composition further comprises a hydrophilic and/or a lipophilic surfactant, wherein said hydrophilic and/or said lipophilic surfactant have a concentration of between 0.01 and 30.00 wt. % based on the total weight of said insecticidal composition.

7. The insecticidal composition according to claim 1, wherein the insecticidal composition has a pH of between 1 and 12.

8. The insecticidal composition according to claim 1, wherein the insecticide is selected from the chemical family of: Acequinocyl, Alkyl halides, Amitraz, Avermectin, Avermectins, Benzoylureas, beta-Ketonitrile derivatives, Bifenazate, Borates, Botanical, Buprofezin, Butenolide, Butenolides, Carbamates, Carboxanilides, Chloropicrin, Clofentezine, Cyanides, Cyclodiene Organochlorines, Cyromazine, Cyromazine, Diacylhydrazine, Diacylhydrazines, Diafenthiuron, Diamide, Diamides, Diflovidazin, Dinitrophenols, Etoxazole, Fenoxycarb, Flonicamid, Fluacrypyrim, Fluorides, Hexythiazox, Hydramethylnon, Juvenile hormone analogues, Mesoionics, Methyl isothiocyanate generators, Milbemycins, Neonicotinoid, Nereistoxin analogues, Organophosphates, Organotin miticides, Oxadiazines, Phenylpyrazoles, Phosphides, Propargite, Pyrethroid, Pyridine azomethine, Pyridine azomethine derivatives, Pyridinecarboxamide, Pyridylidenes, Pyriproxyfen, Pyropenes, Pyrroles, Quinazoline, Semicarbazones, Spinosyns, Sulfluramid, Sulfoximines, Tartar emetic, Tetradifon, Tetronic and Tetramic acid derivatives, or veratrum alkaloids.

9. A method for control of pests in crops, and industrial vegetation or crop management comprising applying an insecticidal composition, characterized in that, the insecticidal composition comprises an insecticide and a polyferulate.

10. The method according to claim 9, wherein the insecticide is applied at 10-90% of its recommended dose, and the polyferulate is applied at a dose of 1-250 g a.i./ha.

11. The method according to claim 9, wherein, the polyferulate is applied to a targeted plant before, simultaneously with, or after application of the insecticide.

12. The method according to claim 11, wherein the polyferulate is applied to the targeted plant simultaneously with the insecticide or in a period of up to 10 days prior to or after applying the insecticide.

13. A kit or pack for control of pests in crops, and industrial vegetation or crop management comprising an insecticidal composition as an in-can or in tank mix, characterized in that, the insecticidal composition comprises a polyferulate and an insecticide, wherein the polyferulate are formulated as adjuvant and added to the insecticide in the tank mix or are applied in a premix concentrate.

14. The kit or pack according to claim 13, wherein the insecticidal composition further comprises a hydrophilic and/or a lipophilic surfactant, wherein said hydrophilic and/or said lipophilic surfactant have a concentration of between 0.01 and 30.00 wt. % based on the total weight of said composition.

15. The kit or pack according to claim 13, wherein the insecticidal composition has a pH of between 1 and 12.
